(19) United States
(12) Patent Application Publication
(10) Pub. No.: US 2018/0219287 A1
(43) Pub. Date: Aug. 2, 2018

(54) ARRAY ANTENNA AND BEAM ALIGNMENT METHOD FOR ARRAY ANTENNA

(71) Applicant: Huawei Technologies Co., Ltd., Shenzhen (CN)

(72) Inventor: Rui Lyu, Chengdu (CN)

(21) Appl. No.: 15/938,788

(22) Filed: Mar. 28, 2018

Related U.S. Application Data
(63) Continuation of application No. PCT/CN2015/091048, filed on Sep. 29, 2015.

(51) Int. Cl. H01Q 3/36; H01Q 21/06

(52) U.S. Cl. CPC H01Q 3/36; H01Q 21/06

(57) ABSTRACT

Embodiments of the present disclosure provide an array antenna and a beam alignment method for an array antenna. The array antenna includes a first subarray, a second subarray, a first power detector, a second power detector, and a decision device, where the first power detector is connected to the first subarray, the second power detector is connected to the second subarray, the decision device is connected to the first power detector, the decision device is connected to the second power detector, and the decision device is configured to determine a first alignment direction of the array antenna according to a power of an output signal of the first subarray and a power of an output signal of the second subarray.

### CROSS-REFERENCE TO RELATED APPLICATIONS

This application is a continuation of International Application No. PCT/CN2015/091048, filed on Sep. 29, 2015, the disclosure of which is hereby incorporated by reference in its entirety.

### TECHNICAL FIELD

Embodiments of the present application disclosure relate to the field of communications technologies, and in particular, to an array antenna and a beam alignment method for an array antenna.

### BACKGROUND

An array antenna is more widely applied to a microwave field, each array element of the array antenna is equipped with a corresponding phase shifter that changes a signal phase, and the phase shifter is generally controlled by using an electrical signal. For a receiving signal, the array element converts the microwave signal into an electrical signal, and the phase shifter performs phase shifting on the electrical signal from the array element and sends the phase-shifted electrical signal to a combiner for combination. A receiving beam direction corresponding to a combined signal may be changed by changing a phase configuration of the phase shifter.

In the prior art, during receiving beam direction alignment, average powers in a plurality of receiving beam directions are collected, and then a better receiving beam direction is determined. To obtain an accurate average power, a detection time for each receiving beam direction needs to be long enough, and therefore, the receiving beam direction alignment takes a relatively long time.

### SUMMARY

Embodiments of the present disclosure provide an array antenna and a beam alignment method for an array antenna, so as to quickly implement array antenna alignment.

According to a first aspect, an array antenna is provided, including a first subarray, a second subarray, a first power detector, a second power detector, and a decision device, where the first power detector is connected to the first subarray, the second power detector is connected to the second subarray, the decision device is connected to the first power detector, the decision device is connected to the second power detector, the first power detector is configured to detect a power of an output signal of the first subarray, the second power detector is configured to detect a power of an output signal of the second subarray, and the decision device is configured to determine a first alignment direction of the array antenna according to the power of the output signal of the first subarray and the power of the output signal of the second subarray.

With reference to the first aspect, in a first possible implementation of the first aspect, the array antenna further includes a third subarray and a third power detector, where the third power detector is connected to the third subarray, the decision device is connected to the third power detector, the third power detector is configured to detect a power of an output signal of the third subarray, and the decision device is specifically configured to determine the first alignment direction of the array antenna according to the power of the output signal of the first subarray, the power of the output signal of the second subarray, and the power of the output signal of the third subarray.

With reference to the first possible implementation of the first aspect, in a second possible implementation of the first aspect, the array antenna further includes a fourth subarray and a fourth power detector, where the fourth power detector is connected to the fourth subarray, the decision device is connected to the fourth power detector, the fourth power detector is configured to detect a power of an output signal of the fourth subarray, and the decision device is specifically configured to determine the first alignment direction of the array antenna according to the power of the output signal of the first subarray, the power of the output signal of the second subarray, the power of the output signal of the third subarray, and the power of the output signal of the fourth subarray.

With reference to the first aspect, in a third possible implementation of the first aspect, the array antenna further includes (N−2) subarrays and (N−2) power detectors, where N is an integer greater than 2, each power detector is connected to a corresponding subarray and is configured to detect a power of an output signal of the corresponding subarray, the decision device is further connected to the (N−2) power detectors, and the decision device is specifically configured to determine the first alignment direction of the array antenna according to the power of the output signal of the first subarray, the power of the output signal of the second subarray, and powers of output signals of the (N−2) subarrays.

With reference to the first to the third possible implementations of the first aspect, in a fourth possible implementation of the first aspect, the decision device is specifically configured to determine the first alignment direction of the array antenna according to a power of the output signal of the first subarray at a first moment and a power of the output signal of the second subarray at the first moment.

With reference to the first to the fourth possible implementations of the first aspect, in a fifth possible implementation of the first aspect, the first subarray includes a first array element, a second array element, a first phase shifter, a second phase shifter, and a first subarray combiner, where the first phase shifter is connected to the first array element, the second phase shifter is connected to the second array element, the first subarray combiner is connected to the first phase shifter, the first subarray combiner is connected to the second phase shifter, the first phase shifter is configured to perform phase shifting on a signal from the first array element and send the signal to the first subarray combiner, the second phase shifter is configured to perform phase shifting on a signal from the second array element and send the signal to the first subarray combiner, and the first subarray combiner is configured to combine the signal from the first phase shifter and the signal from the second phase shifter, and output a signal.

With reference to the first to the fifth possible implementations of the first aspect, in a sixth possible implementation of the first aspect, the array antenna further includes an array antenna combiner, where the array antenna combiner is connected to the first subarray, the array antenna combiner is connected to the second subarray, and the array antenna combiner is configured to combine a signal from the first subarray and a signal from the second subarray.

With reference to the first to the sixth possible implementations of the first aspect, in a seventh possible implementation of the first aspect, the first power detector is specifically configured to detect a power of a coupling signal of the signal sent by the first subarray to the array antenna combiner, and the second power detector is specifically configured to detect a power of a coupling signal of the signal sent by the second subarray to the array antenna combiner.

According to a second aspect, a beam alignment method for an array antenna is provided, the array antenna includes at least a first subarray and a second subarray, and the method includes:

setting a receiving beam direction corresponding to an output signal of the first subarray as a first direction;

setting a receiving beam direction corresponding to an output signal of the second subarray as a second direction, where the second direction is different from the first direction;

detecting a power of the output signal of the first subarray;

detecting a power of the output signal of the second subarray; and

determining a first alignment direction of the array antenna according to the power of the output signal of the first subarray and the power of the output signal of the second subarray.

With reference to the second aspect, in a first possible implementation of the second aspect, the determining a first alignment direction of the array antenna according to the power of the output signal of the first subarray and the power of the output signal of the second subarray specifically includes:

determining the first alignment direction of the array antenna according to a power of the output signal of the first subarray at a first moment and a power of the output signal of the second subarray at the first moment.

With reference to the second aspect or the first possible implementation, in a second possible implementation of the second aspect, before the setting a receiving beam direction corresponding to an output signal of the first subarray as a first direction, the method further includes:

setting the receiving beam direction corresponding to the output signal of the first subarray and the receiving beam direction corresponding to the output signal of the second subarray as a second alignment direction, or

setting a receiving beam direction corresponding to an output signal of the array antenna as a second alignment direction.

With reference to the second possible implementation of the second aspect, in a third possible implementation of the second aspect, an included angle between the first direction and the second alignment direction is the same as an included angle between the second direction and the second alignment direction.

With reference to the first to the third possible implementations of the second aspect, in a fourth possible implementation of the second aspect, projection of the first direction on the array antenna and projection of the second direction on the array antenna are in a line.

With reference to the second possible implementation of the second aspect, in a fifth possible implementation of the second aspect, the array antenna further includes a third subarray, and the method further includes:

setting a receiving beam direction corresponding to an output signal of the third subarray to a third direction, where an included angle between the first direction and the second alignment direction, an included angle between the second direction and the second alignment direction, and an included angle between the third direction and the second alignment direction are the same, and a difference between every adjacent two of projection of the first direction on the array antenna, projection of the second direction on the array antenna, and projection of the third direction on the array antenna is 120 degrees;

detecting a power of the output signal of the third subarray; and

the determining a first alignment direction of the array antenna according to the power of the output signal of the first subarray and the power of the output signal of the second subarray includes:

determining the first alignment direction of the array antenna according to the power of the output signal of the first subarray at the first moment, the power of the output signal of the second subarray at the first moment, and a power of the output signal of the third subarray at the first moment.

With reference to the second possible implementation of the second aspect, in a sixth possible implementation of the second aspect, the array antenna further includes a third subarray and a fourth subarray, and the method further includes:

setting a receiving beam direction corresponding to an output signal of the third subarray to a third direction, and setting a receiving beam direction corresponding to an output signal of the fourth subarray to a fourth direction, where an included angle between the first direction and the second alignment direction, an included angle between the second direction and the second alignment direction, an included angle between the third direction and the second alignment direction, and an included angle between the fourth direction and the second alignment direction are the same, and a difference between every adjacent two of projection of the first direction on the array antenna, projection of the second direction on the array antenna, projection of the third direction on the array antenna, and projection of the fourth direction on the array antenna is 90 degrees;

detecting a power of the output signal of the third subarray;

detecting a power of the output signal of the fourth subarray; and

the determining a first alignment direction of the array antenna according to the power of the output signal of the first subarray and the power of the output signal of the second subarray includes:

determining the first alignment direction of the array antenna according to the power of the output signal of the first subarray at the first moment, the power of the output signal of the second subarray at the first moment, a power of the output signal of the third subarray at the first moment, and a power of the output signal of the fourth subarray at the first moment.

With reference to the second possible implementation of the second aspect, in a seventh possible implementation of the second aspect, the array antenna further includes a fifth subarray, and the method further includes:

setting a receiving beam direction corresponding to an output signal of the fifth subarray to the second alignment direction;

detecting a power of the output signal of the fifth subarray; and

the determining a first alignment direction of the array antenna according to the power of the output signal of the first subarray and the power of the output signal of the second subarray includes:

determining the first alignment direction of the array antenna according to the power of the output signal of the first subarray at the first moment, the power of the output signal of the second subarray at the first moment, and a power of the output signal of the fifth subarray at the first moment.

With reference to the first to the seventh possible implementations of the second aspect, in an eight possible implementation of the second aspect, before the setting a receiving beam direction corresponding to an output signal of the first subarray as a first direction, the method further includes: determining that a power of the output signal of the array antenna is less than a first threshold; or determining that a timer expires.

With reference to the first to the eighth possible implementations of the second aspect, in a ninth possible implementation of the second aspect, the first subarray and the second subarray have equal receiving areas.

With reference to the first to the ninth possible implementations of the second aspect, in a tenth possible implementation of the second aspect, the determining a first alignment direction of the array antenna according to the power of the output signal of the first subarray and the power of the output signal of the second subarray includes: if the power of the output signal of the first subarray is greater than the power of the output signal of the second subarray, and a power difference is greater than a second threshold, determining that the first alignment direction is the first direction.

Therefore, the array antenna provided in the embodiments of the present disclosure includes at least two subarrays, two power detectors, and one decision device. The two power detectors may detect the powers of the output signals of the corresponding subarrays at the same time, and therefore, the decision device may determine the first alignment direction of the array antenna according to the powers of the output signals of the two subarrays. The two power detectors detect a same incident signal at a same moment. Therefore, a better receiving beam direction may be directly obtained by means of comparison, and an average power within a period of time does not need to be collected, thereby quickly implementing array alignment.

### BRIEF DESCRIPTION OF DRAWINGS

To describe the technical solutions in the embodiments of the present disclosure more clearly, the following briefly describes the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of an array antenna according to an embodiment of the present disclosure;

FIG. 2 is a schematic structural diagram of a subarray according to an embodiment of the present disclosure;

FIG. 3 is a schematic structural diagram of another subarray according to an embodiment of the present disclosure;

FIG. 4 is a schematic flowchart of a beam alignment method for an array antenna according to an embodiment of the present disclosure;

FIG. 5 is a schematic diagram of a subarray arrangement according to an embodiment of the present disclosure; and

FIG. 6 is a schematic diagram of another subarray arrangement according to an embodiment of the present disclosure.

### DESCRIPTION OF EMBODIMENTS

The following clearly describes the technical solutions in the embodiments of the present disclosure with reference to the accompanying drawings in the embodiments of the present disclosure.

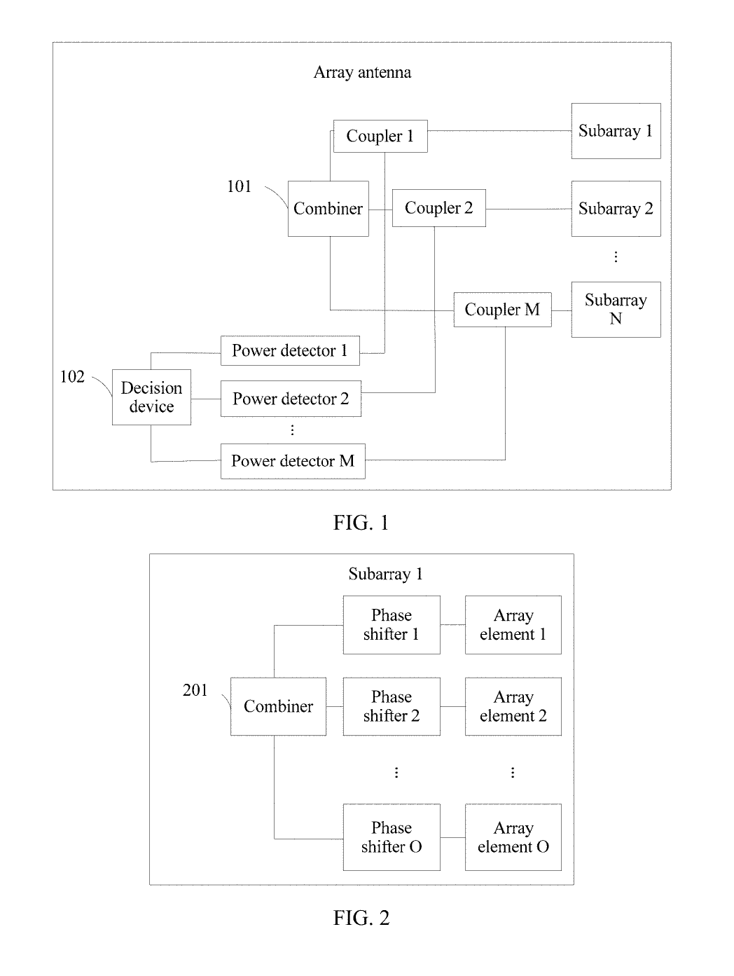

FIG. 1 is a schematic structural diagram of an array antenna according to an embodiment of the present disclosure. The array antenna includes a total of N subarrays: a subarray 1, a subarray 2, . . . , and a subarray N, a total of M couplers: a coupler 1, a coupler 2, . . . , and a coupler M, and a total of M power detectors: a power detector 1, a power detector 2, . . . , and a power detector M, wherein N and M are integers greater than 1, and N and M may be the same or may be different. The array antenna further includes a combiner 101 and a decision device 102. The combiner 101 is connected to the N subarrays, and may be connected to M subarrays of the N subarrays by using the M couplers, the decision device 102 is connected to the M power detectors, and the M power detectors are connected to the M couplers respectively.

At a communication stage, receiving beam directions corresponding to output signals of the N subarrays may be set as a same direction, for example, all are set as a first alignment direction. In this way, the combiner 101 receives and combines the output signals of the N subarrays, and after combining, a receiving beam direction corresponding to an output signal of the combiner 101 is the first alignment direction. Then, processing (not shown in the figure) such as frequency conversion and analog-to-digital conversion may be performed on the output signal obtained after the combiner 101 performs combination. In this case, the M coupler may not operate, that is, no energy is coupled to the power detectors, and all energy is sent to the combiner 101; or the M couplers may operate, that is, some energy is coupled to the power detectors for monitoring. Certainly, only the receiving beam direction corresponding to the output signal obtained after the combiner 101 performs combination may be set as the first alignment direction, and a receiving beam direction corresponding to an output signal of each subarray does not need to be considered.

At a monitoring and adjusting stage, receiving beam directions corresponding to output signals of the M subarrays corresponding to the M coupler need to be set as different directions, or certainly, receiving beam directions corresponding to output signals of some subarrays of the M subarrays may be set as a same direction. In this case, a subarray other than the M subarrays may be set to an original alignment direction and continues to operate. If differences between receiving beam directions of the M subarrays and the first alignment direction are not large, the output signal of the combiner 101 is not greatly affected. The M power detectors detect powers of the output signals of the M subarrays, and the decision device determines, according to the powers of the output signals of the M subarrays, which receiving beam direction should be selected for performing receiving, that is, obtains an optimized alignment direction of the array antenna. If the optimized alignment direction is different from the original first alignment direction, the optimized alignment direction may be used at a next communication stage to receive a signal.

It should be noted that this embodiment of the present disclosure is intended to resolve a beam alignment problem for signal receiving. Therefore, the array antenna may include only some components in FIG. 1. For example, the array antenna includes two subarrays, two power detectors, and one decision device. Another component and a connection relationship in this embodiment of the present disclosure are only for ease of description and for ease of understanding of the solution, and may be implemented in another manner or may not be implemented. This is not limited in this embodiment of the present disclosure.

The array antenna may include a first subarray, a second subarray, a first power detector, a second power detector, and a decision device. The first power detector is connected to the first subarray, the second power detector is connected to the second subarray, the decision device is connected to the first power detector and the second power detector, the first power detector is configured to detect a power of an output signal of the first subarray, the second power detector is configured to detect a power of an output signal of the second subarray, and the decision device is configured to determine a first alignment direction of the array antenna according to the power of the output signal of the first subarray and the power of the output signal of the second subarray.

The array antenna may further include a third subarray and a third power detector. The third power detector is connected to the third subarray, the decision device is connected to the third power detector, the third power detector is configured to detect a power of an output signal of the third subarray, and the decision device is specifically configured to determine the first alignment direction of the array antenna according to the power of the output signal of the first subarray, the power of the output signal of the second subarray, and the power of the output signal of the third subarray.

The array antenna may further include a fourth subarray and a fourth power detector. The fourth power detector is connected to the fourth subarray, the decision device is connected to the fourth power detector, the fourth power detector is configured to detect a power of an output signal of the fourth subarray, and the decision device is specifically configured to determine the first alignment direction of the array antenna according to the power of the output signal of the first subarray, the power of the output signal of the second subarray, the power of the output signal of the third subarray, and the power of the output signal of the fourth subarray.

The decision device may be specifically configured to determine the first alignment direction of the array antenna according to a power of the output signal of the first subarray at a first moment and a power of the output signal of the second subarray at the first moment.

The array antenna may further include an array antenna combiner. The array antenna combiner is connected to the first subarray and the second subarray, and the array antenna combiner is configured to combine a signal from the first subarray and a signal from the second subarray. If there are a third subarray, a fourth subarray, and the like, the array antenna combiner is further connected to these subarrays, and combines output signals received from these subarrays.

The first power detector is specifically configured to detect a power of a coupling signal of the signal sent by the first subarray to the array antenna combiner, and the second power detector is specifically configured to detect a power of a coupling signal of the signal sent by the second subarray to the array antenna combiner. That is, signal coupling is performed by using the coupler in FIG. 1, and the signal is sent to the power detector for power detection; or certainly, power detection may be directly performed on the output signal of the subarray.

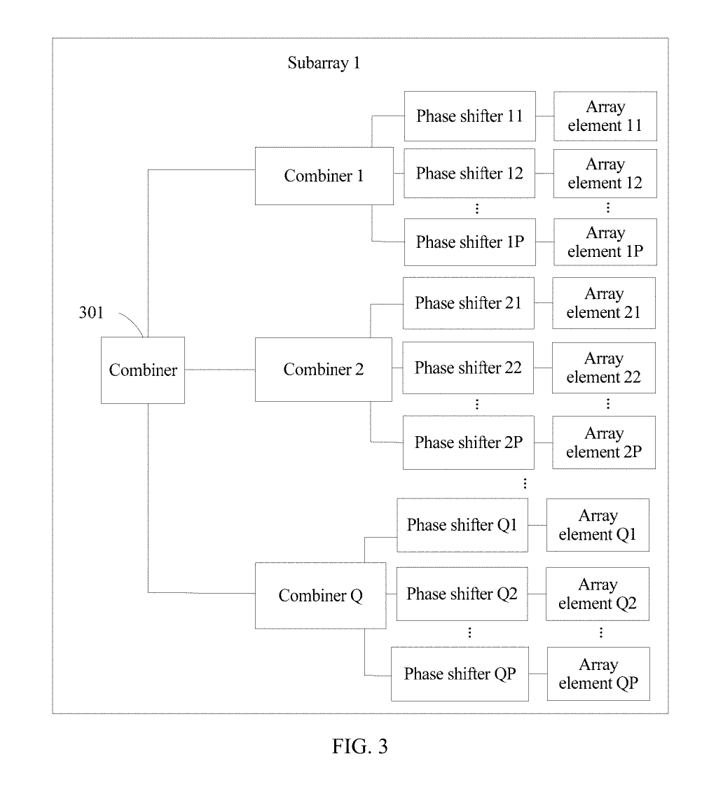

The following uses a subarray structure to describe how to set the receiving beam direction corresponding to the output signal of the subarray. The subarray in FIG. 1 may be implemented in a plurality of manners, and two manners are used as examples for description in the following by using FIG. 2 and FIG. 3.

FIG. 2 is a schematic structural diagram of a subarray according to an embodiment of the present disclosure. The subarray includes a total of O array elements: an array element 1, an array element 2, . . . , and an array element O, a total of O phase shifters: a phase shifter 1, a phase shifter 2, . . . , and a phase shifter O, and further includes one subarray combiner 201, wherein O is an integer greater than 1. The array element is configured to receive a radio signal, for example, a microwave signal, and the array element converts the received microwave signal into an electrical signal. The phase shifter performs phase shifting on a phase of a corresponding electrical signal. The subarray combiner 201 receives and combines signals from the 0 phase shifters. If this is applied to the array antenna shown in FIG. 1, an output signal obtained after the subarray combiner 201 performs combination is sent to the combiner 101 for subsequent processing. Strength of a signal obtained after the subarray combiner performs combination may be changed by setting a parameter of the phase shifter, that is, a receiving beam direction corresponding to an output signal of the subarray may be set.

The following simply describes a rule of setting the receiving beam direction corresponding to the output signal of the subarray by setting the parameter of the phase shifter. For example, the O array elements are arranged to form a one-dimensional 1*O array in space. It is assumed that a vector of a signal received by each array element at a moment t is R(t)=s(t)[1,e^{jα}, e^{j2α}, . . . , e^{j(O-1)α}]=s(t)A(α), where A(α) is a direction vector of an incident signal s(t) at the time of arriving at an array plane. When the subarray forms a beam in a direction θ, a weighted vector of the phase shifter is W(θ)=[w₁(θ), w₂, . . . , w_{O}(θ)]. In this case, signal energy P(t) of the signal obtained by performing combination by the subarray combiner 201 may be expressed as

$$P ( t ) = \vert R ( t ) \cdot {W}^{T} ( θ ) {\vert}^{2} = \vert s ( t ) \cdot {\sum }_{i = 1}^{O} {w}_{i} ( θ ) {e}^{j ( i - 1 ) α} {\vert}^{2} .$$

It is set that so that W(θ)=[w₁(θ), w₂(θ), . . . , w_{O}(θ)], so that wᵢ(θ)e^{j(i-1)α}=1, that is, the receiving beam direction corresponding to the output signal of the subarray is set as a direction corresponding to A(α).

FIG. 3 is a schematic structural diagram of a subarray according to an embodiment of the present disclosure. The subarray includes Q groups. A first group includes a total of P array elements: an array element 11, an array element 12, . . . , and an array element 1P, a total of P phase shifters: a phase shifter 11, a phase shifter 12, . . . , and a phase shifter 1P, and further includes a combiner 1. P and Q are integers greater than 1, each array element is corresponding to one phase shifter, and a signal on which phase shifting is performed is sent to the combiner 1. Structures of a second group to a Q^{th} group are the same as the structure of the first group, and are not described herein. Signals obtained after the Q combiners perform combination are sent to a subarray combiner 301, and the subarray combiner 301 receives and combines the signals from the Q combiners. If this is applied to the array antenna shown in FIG. 1, a signal obtained after the subarray combiner 301 performs combination is sent to the combiner 101 for subsequent processing. Strength of an output signal of the subarray combiner may be changed by setting a parameter of a phase shifter of each group, that is, a receiving beam direction corresponding to an output signal of the subarray may be set.

In FIG. 3, a receiving beam direction corresponding to the output signal obtained after the subarray combiner 301 performs combination may be set by setting the phase shifter of each group. For example, the receiving beam direction is set as a first direction. Specifically, a total of P phase shifters: the phase shifter 11, the phase shifter 12, . . . , and the phase shifter 1P may be set, to make a beam direction corresponding to a receiving signal obtained after the combiner 1 performs combination be the first direction. Phase shifters of other groups are set, to make all beam directions corresponding to receiving signals obtained after a combiner 2 to a combiner Q perform combination be the first direction. In this way, a beam direction corresponding to a receiving signal obtained after the combiner 31 performs combination is also the first direction. Certainly, other setting may be performed. For example, the PxQ phase shifters may be set on the whole, to make the beam direction corresponding to the receiving signal obtained after the combiner 301 performs combination be the first direction, but a receiving beam direction corresponding to an output signal of a combiner of each group may not be the first direction. This is not limited in the present disclosure.

The array antenna is usually installed on a tower, and therefore, a strong wind and another factor may cause a movement of the array antenna. Consequently, a beam direction of a receiving signal needs to be changed so as to improve energy, a signal-to-noise ratio, and the like of the receiving signal. In this embodiment of the present disclosure, the beam direction corresponding to the receiving signal may be monitored and adjusted. The following describes a method for monitoring and adjusting the beam direction corresponding to the receiving signal.

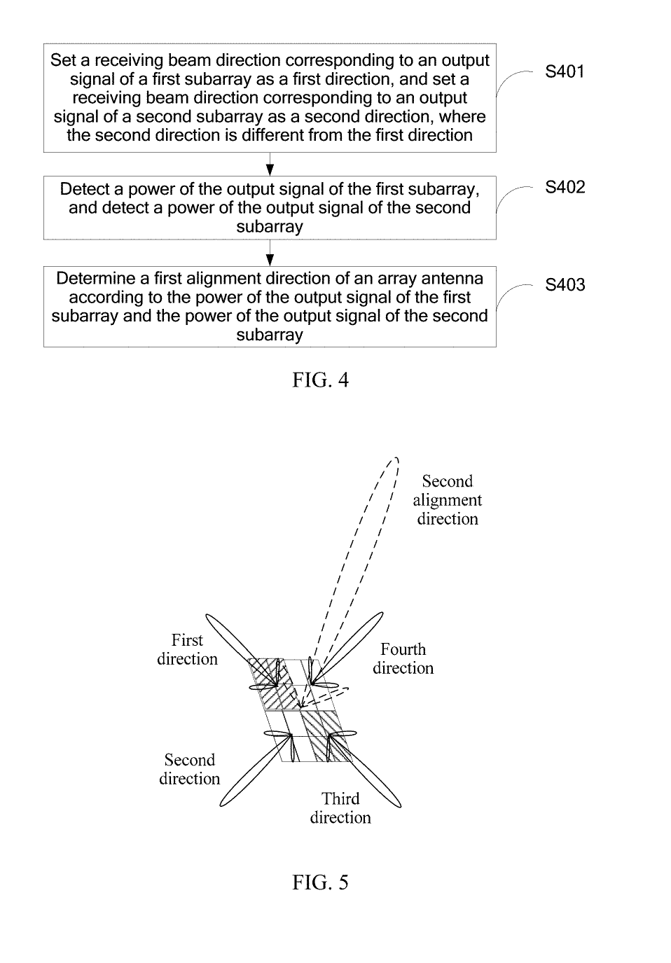

FIG. 4 is a flowchart of a beam alignment method for an array antenna according to an embodiment of the present disclosure. The array antenna includes at least a first subarray and a second subarray, and the method includes the following steps.

S401. Set a receiving beam direction corresponding to an output signal of the first subarray as a first direction, and set a receiving beam direction corresponding to an output signal of the second subarray as a second direction, where the second direction is different from the first direction.

S402. Detect a power of the output signal of the first subarray, and detect a power of the output signal of the second subarray.

S403. Determine a first alignment direction of the array antenna according to the power of the output signal of the first subarray and the power of the output signal of the second subarray.

In step S402, the power of the output signal of the first subarray and the power of the output signal of the second subarray may be detected at the same time. Therefore, the power of the output signal of the first subarray and the power of the output signal of the second subarray may be compared at the same time, so as to determine which subarray is corresponding to a better receiving direction. Therefore, in step S403, the first alignment direction of the array antenna may be determined according to a power of the output signal of the first subarray at a first moment and a power of the output signal of the second subarray at the first moment. Because power values of the output signal of the first subarray and the output signal of the second subarray only at a moment need to be compared, a determining speed is quite fast. Certainly, values at more moments may be determined, and weighted averaging may be performed, so as to ensure accuracy of determining the alignment direction.

To ensure accuracy and a speed of determining the first alignment direction, this embodiment of the present disclosure may be applied to monitoring and adjusting of the alignment direction. That is, before S401 is performed, the array antenna has performed normal communication. For example, the array antenna has performed normal receiving in a second alignment direction. However, a strong wind or another factor causes a power reduction of an output signal of a combiner of the array antenna. For example, the power is less than a threshold. In this case, step S401 may be performed for beam alignment, or a timer may be set to periodically perform step S401, so as to monitor whether a receiving beam direction can be optimized. Certainly, step S401 may be triggered by another trigger condition. This is not limited in this embodiment of the present disclosure.

Therefore, before step S401, the method may further include: setting the receiving beam direction corresponding to the output signal of the first subarray and the receiving beam direction corresponding to the output signal of the second subarray to a second alignment direction, or setting a receiving beam direction corresponding to an output signal of the array antenna to a second alignment direction.

Before step S401, the array antenna performs normal receiving in the second alignment direction. Therefore, subsequent monitoring and adjusting may be performed based on the second alignment direction.

If two subarrays are used for monitoring and adjusting the alignment direction, it may be specified that an included angle between the first direction and the second alignment direction is the same as an included angle between the second direction and the second alignment direction, and projection of the first direction on the array antenna and projection of the second direction on the array antenna are in a line. In this case, the first alignment direction of the array antenna may be determined by comparing only the power of the output signal of the first subarray with the power of the output signal of the second subarray. For example, if the power of the output signal of the first subarray is greater than the power of the output signal of the second subarray, the first direction may be set as the first alignment direction. In a subsequent communication process, the receiving direction corresponding to the output signal of the array antenna is set as the first direction, that is, the first alignment direction.

If three subarrays are used for monitoring and adjusting the alignment direction, step S401 further includes setting a receiving beam direction corresponding to an output signal of a third subarray to a third direction. It may be specified that an included angle between the first direction and the second alignment direction, an included angle between the second direction and the second alignment direction, and an included angle between the third direction and the second alignment direction are the same, and a difference between every adjacent two of projection of the first direction on the array antenna, projection of the second direction on the array antenna, and projection of the third direction on the array antenna is 120 degrees. Step S402 further includes detecting a power of the output signal of the third subarray. Step S403 specifically includes: determining the first alignment direction of the array antenna according to the power of the output signal of the first subarray, the power of the output signal of the second subarray, and the power of the output signal of the third subarray. For example, the first alignment direction of the array antenna may be determined according to the power of the output signal of the first subarray at the first moment, the power of the output signal of the second subarray at the first moment, and a power of the output signal of the third subarray at the first moment.

If four subarrays are used for monitoring and adjusting the alignment direction, step S401 further includes: setting a receiving beam direction corresponding to an output signal of a third subarray to a third direction, and setting a receiving beam direction corresponding to an output signal of a fourth subarray to a fourth direction. It may be specified that an included angle between the first direction and the second alignment direction, an included angle between the second direction and the second alignment direction, an included angle between the third direction and the second alignment direction, and an included angle between the fourth direction and the second alignment direction are the same, and a difference between every adjacent two of projection of the first direction on the array antenna, projection of the second direction on the array antenna, projection of the third direction on the array antenna, and projection of the fourth direction on the array antenna is 90 degrees. Step S402 further includes detecting a power of the output signal of the third subarray, and detecting a power of the output signal of the fourth subarray. Step S403 specifically includes determining the first alignment direction of the array antenna according to the power of the output signal of the first subarray, the power of the output signal of the second subarray, the power of the output signal of the third subarray, and the power of the output signal of the fourth subarray. For example, the first alignment direction of the array antenna may be determined according to the power of the output signal of the first subarray at the first moment, the power of the output signal of the second subarray at the first moment, a power of the output signal of the third subarray at the first moment, and a power of the output signal of the fourth subarray at the first moment.

If the timer is set to periodically perform step S401 so as to monitor whether the receiving beam direction can be optimized, in this case, the original second alignment direction may still be the better direction and does not need to be optimized. In this case, a power value of the original second alignment direction needs to be compared. For example, directions corresponding to two subarrays are set as directions different from the second alignment direction, and a direction corresponding to one subarray is set as the second alignment direction. In this way, step S401 further includes setting a receiving beam direction corresponding to an output signal of a fifth subarray to the second alignment direction. Step S402 further includes detecting a power of the output signal of the fifth subarray. Step S403 is specifically: determining the first alignment direction of the array antenna according to the power of the output signal of the first subarray at the first moment, the power of the output signal of the second subarray at the first moment, and a power of the output signal of the fifth subarray at the first moment. For example, the first alignment direction of the array antenna may be determined according to the power of the output signal of the first subarray at the first moment, the power of the output signal of the second subarray at the first moment, and a power of the output signal of the fifth subarray at the first moment. Certainly, when two subarrays are used to monitor and adjust the alignment direction, a direction of one of the two subarrays may be set as the second alignment direction. For example, the first direction is set as the second alignment direction, and the second direction is changed according to a specified rule, for example, the second direction rotates around the second alignment direction, so as to perform alignment efficiently.

In step S403, the first alignment direction of the array antenna needs to be determined according to the power of the output signal of the first subarray and the power of the output signal of the second subarray. If two subarrays are used to monitor and adjust the alignment direction, the first alignment direction may be obtained only according to powers of output signals of the two subarrays. If more subarrays are used to monitor and adjust the alignment direction, the first alignment direction may be obtained according to powers of output signals of the corresponding subarrays. For example, two subarrays are used to monitor and adjust the alignment direction. In this case, for ease of determining the first alignment direction, it may be configured that the first subarray and the second subarray have equal receiving areas. Certainly, if receiving areas of the first subarray and the second subarray are not equal, the power of the output signal of the first subarray and the power of the output signal of the second subarray may be converted according to the receiving areas, so as to obtain power values based on a same area, and then make a comparison to determine the first alignment direction. Alternatively, another algorithm may be used to perform calculation so as to determine the first alignment direction. This is not limited in this embodiment of the present disclosure.

In this embodiment of the present disclosure, in step S403, the first alignment direction may be determined by using a simple method. For example, when two subarrays are used to monitor and adjust the alignment direction, if the power of the output signal of the first subarray is greater than the power of the output signal of the second subarray, and a power difference is greater than a second threshold, the first alignment direction is the first direction; or if the power of the output signal of the first subarray is greater than the power of the output signal of the second subarray, and a power difference is less than a third threshold, another direction between the first direction and the second direction is calculated according to a specific rule and is used as the first alignment direction. If more than two subarrays are used to monitor and adjust the alignment direction, a similar rule may be used to determine the first alignment direction.

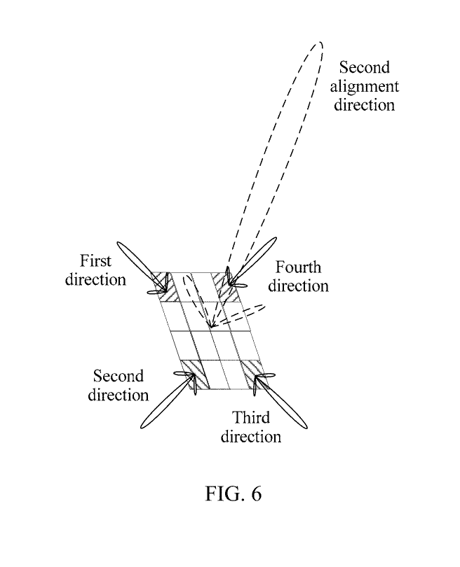

To vividly describe a possible subarray arrangement relationship, so as to understand the solution easily, FIG. 5 and FIG. 6 are used for brief description in the following. In FIG. 5 and FIG. 6, 16 subarrays are arranged in a 4×4 manner.

In FIG. 5, at a normal communication moment, all subarrays form a single receiving beam, that is, a second alignment direction.

When perceiving that a receiving power of a communications link is reduced to a threshold, a system determines that a relative displacement occurs between physical devices in the link, and therefore, starts alignment detection to perform beam alignment. In this case, four 2×2 subarray areas form four independent beams respectively in different directions, and all beams are centered on the second alignment direction at the normal communication moment, and stretch at a fixed offset angle in a “ [symbol] ” shape. That is, included angles between directions of all the beams and the second alignment direction are the same, and projection of all the beams on an array plane is mutually separated at an interval of 90 degrees. The four directions are corresponding to a first direction, a second direction, a third direction, and a fourth direction in FIG. 5.

Receiving signals are combined in the entire array in a staged combination manner. That is, signal combination is first performed in subarrays in each 2×2 area separately, and reference may be made to the combiner 301 in FIG. 3. Then, final signal combination is performed on combined signals in the four areas, and reference may be made to the combiner 101 in FIG. 1. During alignment detection, four copy signals are respectively coupled from the combined signals in the four areas, and reference may be made to the M couplers in FIG. 1. Then, the four copy signals are sent to four separate power detectors for power detection, and reference may be made to the M power detectors in FIG. 1. Outputs of the power detectors are sent to a decision device for beam alignment direction determining, and reference may be made to the decision device 102 in FIG. 1.

The decision device samples outputs of four power detection units at a same moment so as to make a comparison. To avoid capturing low-level moment signals because of signal fluctuation, a decision unit may continuously sample detection powers at two or three moments, and select sample values at a moment when the powers are the largest so as to make a comparison. If there is one obvious largest power among four inputs, a beam direction in an area corresponding to the power is used as a first alignment direction for normal communication in a next period, and a phase offset value of an entire transceiver array is updated based on a phase offset value of a phase shifter in the area, so as to change a transceiver beam direction and implement alignment. If several approximate powers are detected among four inputs, an equal-gain intersection point of beams in these areas may be used as a first alignment direction for normal communication in a next period, and a phase offset value of an entire transceiver array is updated based on an average value of phase offset values of phase shifters in these areas, so as to change a transceiver beam direction and implement alignment.

In FIG. 6, at a normal communication moment, all arrays form a single receiving beam, that is, a second alignment direction.

A communications system periodically allocates an alignment detection timeslot in terms of time. In the alignment detection timeslot, subarrays at four corners form four independent beams respectively in different directions, and all beams are centered on the second alignment direction at the normal communication moment, and stretch at a fixed offset angle in a “ [symbol] ” shape. That is, included angles between all the beams and the second alignment direction are the same, and projection of all the beams on an array plane is mutually separated at an interval of 90 degrees. At the same time, phase configurations of subarrays in other areas of an array keep unchanged, and the second alignment direction is maintained, so as to ensure normal link communication at a detection moment. The four directions are corresponding to a first direction, a second direction, a third direction, and a fourth direction in FIG. 6.

Before subarray signals are combined, five copy signals are respectively coupled from four offset beam subarrays and any one of immobile beam subarrays. The coupling signals are sent to five separate power detectors for power detection. Outputs of the power detectors are sent to a decision device for beam alignment direction determining.

The decision device samples outputs of five power detection units at a same moment so as to make a comparison. To avoid capturing low-level moment signals because of signal fluctuation, a decision unit may continuously sample detection powers at two or three moments, and select sample values at a moment when the powers are the largest so as to make a comparison. If there is one obvious largest power among the five inputs, a beam direction in an area corresponding to the power is used as a first alignment direction for normal communication in a next period, and a phase offset value of an entire transceiver array is updated based on a phase offset value of a phase shifter in the area, so as to change a transceiver beam direction and implement alignment. If several approximate powers are detected among the five inputs, an equal-gain intersection point of beams in these areas is used as a first alignment direction for normal communication in a next period, and a phase offset value of an entire transceiver array is updated based on an average value of phase offset values of phase shifters in these areas, so as to change a transceiver beam direction and implement alignment.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

1. An array antenna, comprising:
a first power detector connected to a first subarray and configured to detect a power of an output signal of the first subarray;
a second power detector connected to a second subarray and configured to detect a power of an output signal of the second subarray;
a decision device connected to the first power detector and the second power detector and configured to determine a first alignment direction of the array antenna according to the power of the output signal of the first subarray and the power of the output signal of the second subarray.

2. The array antenna according to claim 1, further comprising:
a third power detector connected to a third subarray and configured to detect a power of an output signal of the third subarray; and
wherein the decision device is connected to the third power detector and configured to determine the first alignment direction of the array antenna according to the power of the output signal of the first subarray, the power of the output signal of the second subarray, and the power of the output signal of the third subarray.

3. The array antenna according to claim 2, further comprising:
a fourth power detector connected to a fourth subarray and configured to detect a power of an output signal of the fourth subarray; and
wherein the decision device is connected to the fourth power detector and configured to determine the first alignment direction of the array antenna according to the power of the output signal of the first subarray, the power of the output signal of the second subarray, the power of the output signal of the third subarray, and the power of the output signal of the fourth subarray.

4. The array antenna according to claim 1, further comprising (N−2) subarrays and (N−2) power detectors, wherein N is an integer greater than 4, each power detector is connected to a corresponding subarray and is configured to detect a power of an output signal of the corresponding subarray, the decision device is further connected to the (N−2) power detectors, and the decision device is configured to determine the first alignment direction of the array antenna according to the power of the output signal of the first subarray, the power of the output signal of the second subarray, and powers of output signals of each of the (N−2) subarrays.

5. The array antenna according to claim 1, wherein the decision device is configured to determine the first alignment direction of the array antenna according to a power of the output signal of the first subarray at a first moment and a power of the output signal of the second subarray at the first moment.

6. The array antenna according to claim 1, wherein the first subarray comprises:
a first phase shifter connected to a first array element and configured to phase shift a signal from the first array element and generate a first phase-shifted signal;
a second phase shifter connected to a second array element and configured to phase shift a signal from the second array element and generate a second phase-shifted signal; and
a first subarray combiner connected to the first phase shifter and the second phase shifter and configured to combine the first phase-shifted signal and the second phase-shifted signal and output a combined signal.

7. The array antenna according to claim 1, further comprising:
an array antenna combiner connected to the first subarray and the second subarray and configured to combine a signal from the first subarray and a signal from the second subarray.

8. The array antenna according to claim 7, wherein the first power detector is configured to detect a power of a coupling signal of the signal sent by the first subarray to the array antenna combiner, and the second power detector is configured to detect a power of a coupling signal of the signal sent by the second subarray to the array antenna combiner.

9. A beam alignment method for an array antenna comprising at least a first subarray and a second subarray, the method comprising:
setting a receiving beam direction corresponding to an output signal of the first subarray as a first direction;
setting a receiving beam direction corresponding to an output signal of the second subarray as a second direction, wherein the second direction is different from the first direction;
detecting a power of the output signal of the first subarray;
detecting a power of the output signal of the second subarray; and
determining a first alignment direction of the array antenna according to the power of the output signal of the first subarray and the power of the output signal of the second subarray.

10. The method according to claim 9, wherein determining a first alignment direction of the array antenna according to the power of the output signal of the first subarray and the power of the output signal of the second subarray comprises:
determining the first alignment direction of the array antenna according to a power of the output signal of the first subarray at a first moment and a power of the output signal of the second subarray at the first moment.

11. The method according to claim 9, wherein before setting a receiving beam direction corresponding to an output signal of the first subarray as a first direction, the method further comprises:
setting the receiving beam direction corresponding to the output signal of the first subarray and the receiving beam direction corresponding to the output signal of the second subarray as a second alignment direction; or
setting a receiving beam direction corresponding to an output signal of the array antenna as a second alignment direction.

12. The method according to claim 11, wherein an included angle between the first direction and the second alignment direction is the same as an included angle between the second direction and the second alignment direction.

13. The method according to claim 9, wherein projection of the first direction on the array antenna and projection of the second direction on the array antenna are in a line.

14. The method according to claim 11, wherein:
the array antenna further comprises a third subarray;
the method further comprises:
setting a receiving beam direction corresponding to an output signal of the third subarray to a third direction, wherein an included angle between the first direction and the second alignment direction, an included angle between the second direction and the second alignment direction, and an included angle between the third direction and the second alignment direction are the same, and a difference between every adjacent two of projection of the first direction on the array antenna, projection of the second direction on the array antenna, and projection of the third direction on the array antenna is 120 degrees, and
detecting a power of the output signal of the third subarray; and
determining a first alignment direction of the array antenna according to the power of the output signal of the first subarray and the power of the output signal of the second subarray comprises:
determining the first alignment direction of the array antenna according to the power of the output signal of the first subarray at the first moment, the power of the output signal of the second subarray at the first moment, and a power of the output signal of the third subarray at the first moment.

15. The method according to claim 11, wherein:
the array antenna further comprises a third subarray and a fourth subarray;
the method further comprises:
setting a receiving beam direction corresponding to an output signal of the third subarray to a third direction, and setting a receiving beam direction corresponding to an output signal of the fourth subarray to a fourth direction, wherein an included angle between the first direction and the second alignment direction, an included angle between the second direction and the second alignment direction, an included angle between the third direction and the second alignment direction, and an included angle between the fourth direction and the second alignment direction are the same, and a difference between every adjacent two of projection of the first direction on the array antenna, projection of the second direction on the array antenna, projection of the third direction on the array antenna, and projection of the fourth direction on the array antenna is 90 degrees,
detecting a power of the output signal of the third subarray, and
detecting a power of the output signal of the fourth subarray; and
determining a first alignment direction of the array antenna according to the power of the output signal of the first subarray and the power of the output signal of the second subarray comprises:
determining the first alignment direction of the array antenna according to the power of the output signal of the first subarray at the first moment, the power of the output signal of the second subarray at the first moment, a power of the output signal of the third subarray at the first moment, and a power of the output signal of the fourth subarray at the first moment.

16. The method according to claim 11, wherein:
the array antenna further comprises a fifth subarray;
the method further comprises:
setting a receiving beam direction corresponding to an output signal of the fifth subarray to the second alignment direction,
detecting a power of the output signal of the fifth subarray; and
determining a first alignment direction of the array antenna according to the power of the output signal of the first subarray and the power of the output signal of the second subarray comprises:
determining the first alignment direction of the array antenna according to the power of the output signal of the first subarray at the first moment, the power of the output signal of the second subarray at the first moment, and a power of the output signal of the fifth subarray at the first moment.

17. The method according to claim 9, wherein before setting a receiving beam direction corresponding to an output signal of the first subarray as a first direction, the method further comprises:
determining that a power of the output signal of the array antenna is less than a first threshold; or
determining that a timer expires.

18. The method according to claim 9, wherein the first subarray and the second subarray have equal receiving areas.

19. The method according to claim 9, wherein determining a first alignment direction of the array antenna according to the power of the output signal of the first subarray and the power of the output signal of the second subarray comprises:
when the power of the output signal of the first subarray is greater than the power of the output signal of the second subarray, and a power difference is greater than a second threshold, determining that the first alignment direction is the first direction.
